(19) United States
(12) Patent Application Publication
(10) Pub. No.: US 2007/0285527 A1
(43) Pub. Date: Dec. 13, 2007

(54) IMAGING APPARATUS AND METHOD, AND PROGRAM

(75) Inventors: Takayoshi Kusayama, Kanagawa (JP); Makibi Nakamura, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/736,749

(22) Filed: Apr. 18, 2007

(30) Foreign Application Priority Data
May 9, 2006 (JP) 2006-130096

(51) Int. Cl. H04N 5/228

(52) U.S. Cl. 348/222.1; 348/E05.031

(57) ABSTRACT

An imaging apparatus for capturing an image, including: imaging means for capturing an image by subjecting an incoming light to photoelectric conversion; operation means for being operated by a user; adding image generation means for adding, while the operation means is being operated, an image captured by the imaging means with an exposure time not long enough for correct exposure, and generating an adding image; and recording control means for recording the adding image to a recording medium when the operation means is stopped for operation.

### CROSS REFERENCES TO RELATED APPLICATIONS

The present invention contains subject matter related to Japanese Patent Application JP 2006-130096 filed in the Japanese Patent Office on May 9, 2006, the entire contents of which being incorporated herein by reference.

### BACKGROUND OF THE INVENTION

1. Field of the Invention

The present invention relates to an imaging apparatus, an imaging method, and a program and, more specifically, to an imaging apparatus, an imaging method, and a program enabling a user to easily acquire an image with his or her desired exposure.

2. Description of the Related Art

An imaging method using a digital camera (digital still camera) includes bulb shooting (imaging), for example. With bulb shooting, the exposure status is kept while a user is depressing a release button (switch), and when the button is freed from being depressed, the exposure is terminated. The bulb shooting is a technique with long-time exposure.

With such bulb shooting, the resulting image is with the exposure of a level in accordance with the exposure time. To see how much exposure the resulting image will have, immediately after a release button is depressed, the intensity gain of an image (pre-shot image) captured with an exposure time not long enough for correct exposure is increased by a level every time a predetermined time, i.e., rewriting interval, passes. As an example, refer to Patent Document 1 (JP-A-2004-235973).

### SUMMARY OF THE INVENTION

The problem with such a method is that, however, the pre-shot image with the increased intensity gain will show a deviation from the actual image to be captured by bulb shooting with the degree not being neglected due to SN (Signal/Noise) of the pre-shot image, for example. If this is the case, the pre-shot image with the increased intensity gain will look different from the actual image to be captured by bulb shooting, thereby failing to derive an image with any desired exposure.

It is thus desirable to enable easy acquisition of an image with user's desired exposure.

According to a first embodiment of the invention, there is provided an imaging apparatus for capturing an image, including: imaging means for capturing an image by subjecting an incoming light to photoelectric conversion; operation means for being operated by a user; adding image generation means for adding, while the operation means is being operated, an image captured by the imaging means with an exposure time not long enough for correct exposure, and generating an adding image; and recording control means for recording the adding image to a recording medium when the operation means is stopped for operation.

The imaging apparatus of the first embodiment may further include display means for displaying an image; and display control means for making, every time the adding image being a new addition result with the image captured by the imaging means is generated, the display means display the adding image being the new addition result.

The imaging apparatus of the first embodiment may further include division means for dividing a pixel value of the adding image by a predetermined value.

The imaging apparatus of the first embodiment may further include correction means for correcting, while the operation means is being operated, the image plurally captured by the imaging means to derive positional alignment of an object therein. In the device, the adding image generation means adds the image through with the correction by the correction means.

According to the first embodiment of the invention, there is also provided an imaging method for use with an imaging apparatus equipped with imaging means for capturing an image by subjecting an incoming light to photoelectric conversion, or a program for use with a computer to execute an imaging process of an imaging apparatus equipped with imaging means for capturing an image by subjecting an incoming light to photoelectric conversion. The imaging method or the program includes the steps of: generating, while operation means for being operated by a user is being operated, an adding image by adding an image captured by the imaging means with an exposure time not long enough for correct exposure; and recording the adding image to a recording medium when the operation means is stopped for operation.

In the first embodiment of the invention, while the operation means for being operated by a user is being operated, the imaging means generates an adding image by adding an image captured by the imaging means with an exposure time not long enough for correct exposure, and when the operation means is stopped for operation, recording the adding image to a recording medium.

According to a second embodiment of the invention, there is provided an imaging apparatus for capturing an image, including: imaging means for capturing an image by subjecting an incoming light to photoelectric conversion; adding image generation means for adding an image captured by the imaging means with an exposure time not long enough for correct exposure, and generating an adding image; display means for displaying an image; and display control means for making, every time the adding image being a new addition result with the image captured by the imaging means is generated, the display means display the adding image being the new addition result.

The imaging apparatus of the second embodiment may further include recording control means for recording the adding image to a recording medium.

The imaging apparatus of the second embodiment may further include division means for dividing a pixel value of the adding image by a predetermined value.

The imaging apparatus of the second embodiment may further include correction means for correcting the image plurally captured by the imaging means to derive positional alignment of an object therein. In the device, the adding image generation means adds the image through with the correction by the correction means.

According to the second embodiment of the invention, there is also provided an imaging method for use with an imaging apparatus equipped with imaging means for capturing an image by subjecting an incoming light to photoelectric conversion, or a program for use with a computer to execute an imaging process of an imaging apparatus equipped with imaging means for capturing an image by subjecting an incoming light to photoelectric conversion. The imaging method or the program includes the steps of: generating an adding image by adding an image captured by the imaging means with an exposure time not long enough for correct exposure; and making, every time the adding image being a new addition result with the image captured by the imaging means is generated, display means display the adding image being the new addition result.

In the second embodiment of the invention, the imaging means generates an adding image by adding an image captured by the imaging means with an exposure time not long enough for correct exposure, and every time the adding image being a new addition result with the image captured by the imaging means is generated, display means is made to display the adding image being the new addition result.

According to the invention, for example, it is easy to acquire an image with user's desired exposure.

### BRIEF DESCRIPTION OF THE DRAWINGS

FIG. 1 is a block diagram showing an exemplary configuration of a digital camera in an embodiment to which the invention is applied;

FIG. 2 is a diagram for illustrating a method of detecting a motion vector of a captured image by a motion vector detection section of FIG. 1 for a second captured image and thereafter;

FIG. 3 is another diagram for illustrating the method of detecting a motion vector of the captured image by the motion vector detection section of FIG. 1 for a second captured image and thereafter;

FIG. 4 is a diagram for illustrating a correction process to be executed by a correction section of FIG. 1 for a second captured image and thereafter;

FIG. 5 is a diagram showing how a new adding image is generated by an adding image generation section of FIG. 1;

FIG. 6 is a diagram showing an adding image displayed on a display section of FIG. 1;

FIG. 7 is a flowchart of a process in a bulb shooting mode;

FIG. 8 is a flowchart of a brightness control process for an adding image; and

FIG. 9 is a block diagram showing an exemplary configuration of a computer.

### DETAILED DESCRIPTION OF THE INVENTION

Prior to describing an embodiment of the invention below, exemplified is a correlation among claimed components and an embodiment in this specification or the accompanying drawings. This is aimed to prove that an embodiment provided for the purpose of supporting the description of claims is described in the specification or in the accompanying drawings. Therefore, even if there are any specific embodiment found in the specification or the accompanying drawings but not found here for the components described in the embodiment of the invention, it does not mean that the embodiment is not correlated to the components. On the other hand, even if there is the embodiment found here for the components, it does not mean that the embodiment is only correlated to the components.

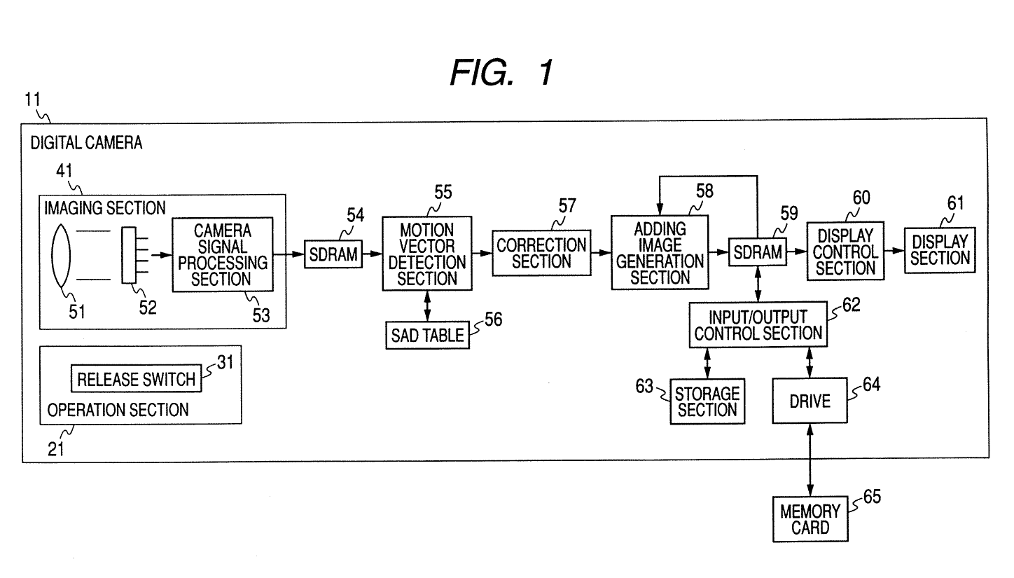

In the first embodiment of the invention, an imaging apparatus (e.g., digital camera 11 of FIG. 1) for capturing an image includes: imaging means (e.g., imaging section 41 of FIG. 1) for capturing an image by subjecting an incoming light to photoelectric conversion; operation means (e.g., operation section 21 of FIG. 1) for being operated by a user; adding image generation means (e.g., adding image generation section 58 of FIG. 1) for adding, while the operation means is being operated, an image captured by the imaging means with an exposure time not long enough for correct exposure, and generating an adding image; and recording control means (e.g., input/output control section 62 of FIG. 1) for recording the adding image to a recording medium (e.g., recording section 63 or memory card 65 of FIG. 1) when the operation means is stopped for operation.

The imaging apparatus of the first embodiment may further include display means (e.g., display section 61 of FIG. 1) for displaying an image; and display control means(e.g., display control section 60 of FIG. 1) for making, every time the adding image being a new addition result with the image captured by the imaging means is generated, the display means display the adding image being the new addition result.

The imaging apparatus of the first embodiment may further include division means (e.g., input/output control section 62 of FIG. 1) for dividing a pixel value of the adding image by a predetermined value.

The imaging apparatus of the first embodiment may further include correction means (e.g., correction section 57 of FIG. 1) for correcting, while the operation means is being operated, the image plurally captured by the imaging means to derive positional alignment of an object therein. In the device, the adding image generation means adds the image through with the correction by the correction means.

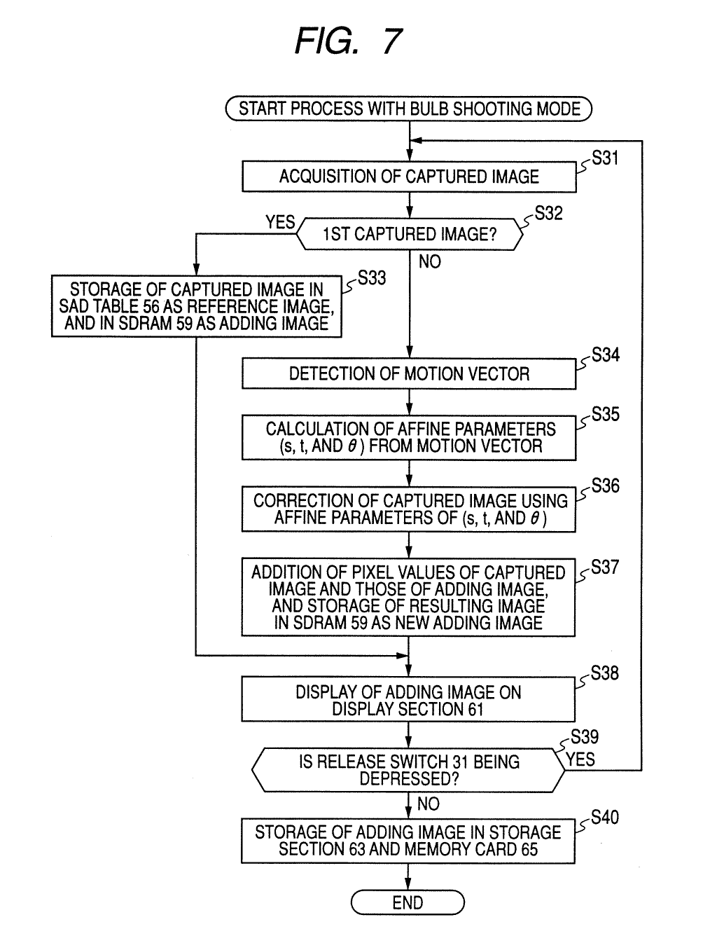

In the first embodiment of the invention, an imaging method for use with an imaging apparatus equipped with imaging means for capturing an image by subjecting an incoming light to photoelectric conversion, or a program for use with a computer to execute an imaging process of an imaging apparatus equipped with imaging means for capturing an image by subjecting an incoming light to photoelectric conversion includes the steps of: generating, while operation means for being operated by a user is being operated, an adding image by adding an image captured by the imaging means with an exposure time not long enough for correct exposure (e.g., step S37 of FIG. 7); and recording the adding image to a recording medium when the operation means is stopped for operation (e.g., step S40 of FIG. 7).

In a second embodiment of the invention, an imaging apparatus (e.g., digital camera 11 of FIG. 1) for capturing an image includes: imaging means (e.g., imaging section 41 of FIG. 1) for capturing an image by subjecting an incoming light to photoelectric conversion; adding image generation means (e.g., adding image generation section 58 of FIG. 1) for adding an image captured by the imaging means with an exposure time not long enough for correct exposure, and generating an adding image; display means (e.g., display section 61 of FIG. 1) for displaying an image; and display control means (e.g., display control section 60 of FIG. 1) for making, every time the adding image being a new addition result with the image captured by the imaging means is generated, the display means display the adding image being the new addition result.

The imaging apparatus of the second embodiment may further include recording control means (e.g., input/output control section 62 of FIG. 1) for recording the adding image to a recording medium.

The imaging apparatus of the second embodiment may further include division means (e.g., input/output control section 62 of FIG. 1) for dividing a pixel value of the adding image by a predetermined value.

The imaging apparatus of the second embodiment may further include correction means (e.g., correction section 57 of FIG. 1) for correcting the image plurally captured by the imaging means to derive positional alignment of an object therein. In the imaging apparatus, the adding image generation means adds the image through with the correction by the correction means.

In the second embodiment of the invention, an imaging method for use with an imaging apparatus equipped with imaging means for capturing an image by subjecting an incoming light to photoelectric conversion, or a program for use with a computer to execute an imaging process of an imaging apparatus equipped with imaging means for capturing an image by subjecting an incoming light to photoelectric conversion includes the steps of: generating an adding image by adding an image captured by the imaging means with an exposure time not long enough for correct exposure (e.g., step S37 of FIG. 7); and making, every time the adding image being a new addition result with the image captured by the imaging means is generated, display means display the adding image being the new addition result (e.g., step S38 of FIG. 7).

In the below, an embodiment of the invention is described by referring to the accompanying drawings.

FIG. 1 is a block diagram showing an exemplary configuration of an embodiment of a digital camera (digital still camera) 11 to which the invention is applied.

The digital camera 11 of FIG. 1 is configured to include an operation section 21, an imaging section 41, an SDRAM (Synchronous Dynamic Random Access Memory) 54, a motion vector detection section 55, an SAD (Sum of Absolute Differences) table 56, a correction section 57, an adding image generation section 58, another SDRAM 59, a display control section 60, a display section 61, an input/output control section 62, a storage section 63, a drive 64, and a memory card 65.

The operation section 21 is configured by a release switch 31, a touch panel overlaid on the display section 61 that will be described later, and others, and is operated by a user. The operation section 21 supplies an operation signal in accordance with the user's operation to any needed block of the digital camera 11. The imaging section 41 captures an image of an object by receiving an incoming light for photoelectric conversion. The resulting captured image is supplied to the SDRAM 54 for (temporary) storage.

The imaging section 41 is configured to include an imaging lens 51, an imaging element 52, and a camera signal processing section 53. The imaging lens 51 forms an image of an object on the light-receiving surface of the imaging element 52. The imaging element 52 is configured by a CCD (Charge Coupled Devices) or CMOS (Complementary Metal Oxide Semiconductor) sensor, for example. The image (light) of the object formed on the light-receiving surface of the imaging element is subjected to photoelectric conversion so that the resulting analog image signal is supplied to the camera signal processing section 53.

To the analog image signal provided by the imaging element 52, the camera signal processing section 53 applies gamma correction, white balance, and others. The camera signal processing section 53 then subjects the analog image signal to A/D (Analog/Digital) conversion, and the resulting digital image signal (captured image) is supplied to the SDRAM 54 for storage therein.

The SDRAM 54 serves to store therein the captured image provided by the camera signal processing section 53 (imaging section 41).

The digital camera 11 has shooting modes of normal shooting and bulb shooting, for example. With the normal shooting mode, in the imaging section 41, imaging is performed with an exposure time, i.e., with correct exposure, responsively when the release switch 31 is depressed once so that a piece of image is captured. With the bulb shooting, a plurality of captured images are added together in accordance with the depression of the release switch 31 so that the resulting image is captured with a predetermined exposure time. In the below, described is a case with the bulb shooting mode. Note here that, with such a bulb shooting mode, the imaging can be performed with substantially long-time exposure similarly to the bulb shooting with which the exposure state remains the same while a user is depressing the release switch 31, and the exposure is terminated when the release switch 31 is freed from being depressed.

If with a normal shooting mode, unlike with the bulb shooting mode, some of the components do not operate, i.e., the motion vector detection section 55, the SAD table 56, the correction section 57, and the adding image generation section 58, which will be described later.

The motion vector detection section 55 reads the images captured by the imaging section 41 from the SDRAM 54 in the captured order. The motion vector detection section 55 supplies, via the correction section 57 and the adding image generation section 58, the first captured image read from the SDRAM 54 to the SDRAM 59 for storage therein as an adding image that will be described later. The first captured image is also supplied to the SAD table 56 for storage therein as a reference image that will be also described later. The first image herein denotes an image captured for the first time by the imaging section 41 after the release switch 31 is depressed.

The adding image denotes an image being a result of addition performed by the adding image generation section 58 (will be described later) for images captured by the imaging section 41. The reference image denotes an image for reference use when the correction section 57 (will be described later) corrects the position of the second image and thereafter, i.e., images captured by the imaging section 41 for a second time and thereafter after the release switch 31 is depressed.

Then n-th captured image denotes an n-th image among other images captured with the bulb shooting mode. That is, with the digital camera 11 in the bulb shooting mode, addition targets are N pieces of images captured while the release switch 31 is being depressed, i.e., after the release switch 31 is depressed but before the release switch 31 is freed from the depression. Among these N images captured while the release switch 31 is being depressed, the n-th captured image is located at the n-th order, i.e., n=1, 2, . . . N−1, and N.

For each of the images read from the SDRAM 54, i.e., the images captured for the second time and thereafter, the motion vector detection section 55 detects a motion vector representing the motion of the captured image with respect to a reference image stored in the SAD table 56. The motion vector detection section 55 supplies the detection results to the correction section 57 together with the captured images.

The SAD table 56 stores therein, as a reference image, the first captured image provided by the motion vector detection section 55.

Based on the motion vector of the captured image provided by the motion vector detection section 55, the correction section 57 corrects the captured image provided by the motion vector detection section 55, and supplies the correction result to the adding image generation section 58.

The adding image generation section 58 adds together the adding image read from the SDRAM 59 and the captured image through with the correction by the correction section 57. The resulting image is supplied to the SDRAM 59 as a new adding image, and is updated and stored therein.

The SDRAM 59 stores therein the adding image provided by the adding image generation section 58.

Every time the adding image generation section 58 generates a new adding image (including the first captured image) for storage in the SDRAM 59, the display control section 60 reads the new adding image from the SDRAM 59 for supply to the display section 61. The display section 61 then displays thereon the adding image.

The display section 61 being under the control of the display control section 60 displays thereon the adding image and others provided by the display control section 60. The display section 61 is exemplified by an LCD (Liquid Crystal Display), and others.

The input/output control section 62 is connected with the SDRAM 59, the storage section 63, and the drive 64. The input/output control section 62 exercises control over the image exchange among the SDRAM 59, the storage section 63, and the drive 64.

The storage section 63 stores therein the images provided by the input/output control section 62.

The drive 64 supplies the images provided by the input/output control section 62 to the memory card 65 for storage therein. The drive 64 also reads the images from the memory card 65 for supply to the input/output control section 62.

The memory card 65 is configured removal to be attachable/detachable to/from the drive 64 of the digital camera 11. The memory card 65 serves to store therein the images provided by the input/output control section 62.

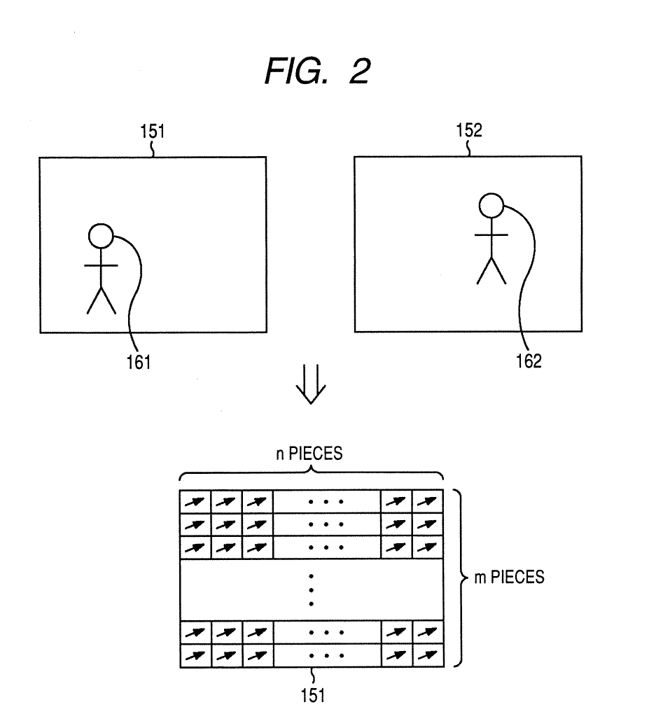

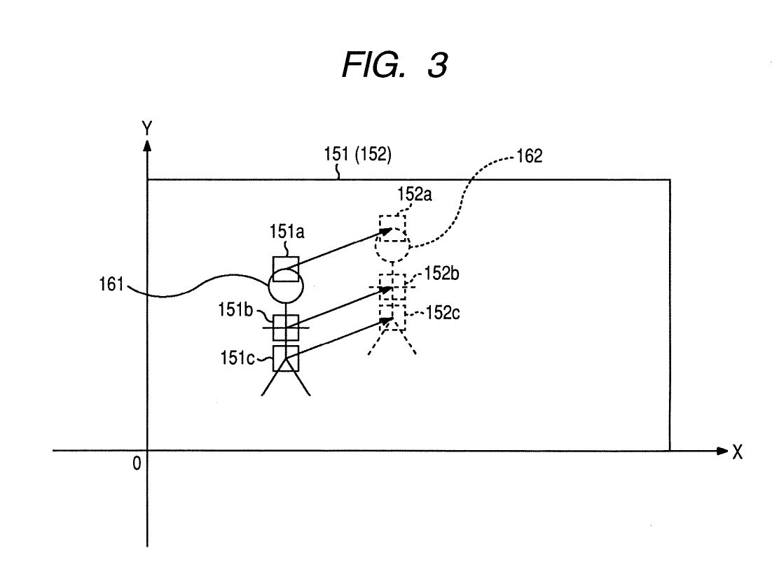

By referring to FIGS. 2 and 3, described next is the processes to be executed by the motion vector detection section 55 of FIG. 1.

FIG. 2 is a diagram showing how the motion vector detection section 55 detects, with a bulb shooting mode, a motion vector representing the motion of images captured for the second time and thereafter.

The upper portion of FIG. 2 shows a reference image 151 including therein an object 161, and a captured image 152 (captured for the second time or thereafter) including therein an object 162 being the object 161. The lower portion of FIG. 2 shows the reference image 151 being divided into m pieces of blocks in the longitudinal direction, and n pieces of blocks in the lateral direction. The arrows in the m×n blocks below the FIG. 2 each denote a motion vector detected for the corresponding block.

As described above, the reference image 151 denotes the first captured image, and the captured image 152 denotes the image captured for the second time or there after. The position displacement observed between the object 161 in the reference image 151 and the object 162 in the captured image 152 is due to camera shake, for example.

Using the reference image 151 and the captured image 152, the motion vector detection section 55 detects a motion vector representing the motion of the captured image 152 with respect to the reference image 151.

That is, as shown in the lower portion of FIG. 2, the motion vector detection section 55 divides the reference image 151 into m pieces of blocks in the longitudinal direction, and n pieces of blocks in the lateral direction. For each of the blocks, the motion vector detection section 55 then finds an area on the captured image 152 being most analogous. As such, block matching is performed for detection of a motion vector.

FIG. 3 is a diagram for illustrating a method of detecting a motion vector by such block matching.

In FIG. 3, the reference image 151 and the captured image 152 are disposed one on the other. In FIG. 3, an xy coordinate system is defined with a lower left point of the reference image 151, i.e., captured image 152, being a point of origin O, and the right direction is x, and the upper direction is y.

As shown in FIG. 3, using blocks 151a to 151c being the division results on the reference image 151 as a template, the motion vector detection section 55 finds areas 152a to 152c on the captured image 152 being most analogous to the blocks 151a to 151c, respectively. The motion vector detection section 55 then detects a motion vector with a starting point of (Cₓ, C_{y}) and an end point of (Cₓ′, C_{y}′). The starting point (Cₓ, C_{y}) is located at the center (barycenter) of the blocks 151a to 151c on the reference image 151, and the end point (Cₓ′, C_{y}′) is located at the center of the areas 152a to 152c.

As such, the motion vector detection section 55 derives the m×n motion vectors detected for the m×n blocks on the reference image 151 shown in the lower portion of FIG. 2. The motion vector detection section 55 then supplies these motion vectors to the correction section 57 together with the captured image 152, i.e., images captured for the second time or thereafter.

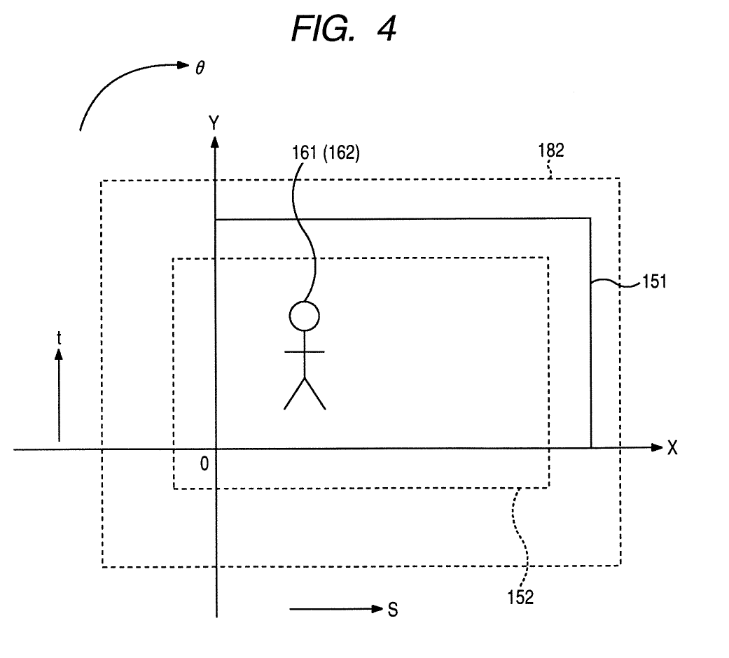

By referring to FIG. 4, described next is the processes to be executed by the correction section 57 of FIG. 1.

The correction section 57 uses the reference image 151 as a reference to correct the captured image 152. That is, the correction section 57 corrects the captured image 152 by affine transformation, for example, for position alignment between the object 161 in the reference image 151 and the object 162 being the object 161 in the captured image 152.

With the affine transformation, the relationship between the position (x, y) of the reference image 151 (pixel thereof) and the position (x′, y′) of the captured image 152 is represented by the following Equation 1.

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} ) + ( \begin{matrix}s \\ t\end{matrix} ) \qquad ( 1 )$$

With the affine transformation of Equation 1, the position (x, y) is rotated by an angle θ around the point of origin O, and then is moved parallel by (x, y)=(s, t) so that the (x, y) is converted, i.e., corrected, to the position (x′, y′).

In the below, the parameters s, t, and θ for use to define the affine transformation of Equation 1 are referred to as affine parameters (s, t, and θ).

Note that, with the affine transformation of Equation 1, no consideration is given to the movement of the digital camera 11 in the direction from the digital camera 11 toward the object. However, the affine transformation can be performed with a consideration given to such a movement. With this being the case, as an alternative to the matrix of 2×2 on the right side of Equation 1, used is a matrix multiplied by a parameter for enlargement/contraction.

Using the m×n motion vectors shown in the lower portion of FIG. 2 and the above Equation 1, the correction section 57 finds the affine parameters (s, t, and θ) by the least squares method.

Specifically, the correction section 57 performs the affine transformation using the above Equation 1 to the position (Cₓ, C_{y}) at the center of the m×n blocks on the reference image 151. The correction section 57 then calculates the motion vector with a starting point being the position (Cₓ, C_{y}) located at the center of the m×n blocks on the reference image 151, and an end point being the position derived by subjecting the position (Cₓ, C_{y}) to the affine transformation as a transformed motion vector V_{GM}. The resulting motion vector is the transformed motion vector V_{GM}, which is represented by the following Equation 2.

$${V}_{GM} = ( \begin{matrix}cos θ & - sin θ \\ sin θ & cos θ\end{matrix} ) ( \begin{matrix}{C}_{x} \\ {C}_{y}\end{matrix} ) + ( \begin{matrix}s \\ t\end{matrix} ) - ( \begin{matrix}{C}_{x} \\ {C}_{y}\end{matrix} ) \qquad ( 2 )$$

In the Equation 2, the transformed motion vector V_{GM} is represented by an equation with the affine parameters (s, t, and θ) each being a variable.

The correction section 57 calculates the affine parameters (s, t, and θ) with which a sum total E of a square error between the transformed motion vector V_{GM} of the blocks on the reference image 151 and the motion vector detected by the block matching described above (hereinafter, referred also to as matching motion vector V_{BM}) will be minimum. The sum total E of the square error is represented by the following Equation 3.

E=Σ|V_{GM}−V_{BM}|² (3)

In the Equation 3, Σ denotes the sum total of the m×n blocks on the reference image 151 shown in the lower portion of FIG. 2. The affine parameters (s, t, and θ) minimizing the sum total E of the square error of the Equation 3 can be calculated by finding an equation in which the sum total E of the square error is subjected to partial differentiation by the affine parameters (s, t, and θ), and then by solving an equation in which thus found equation is set to 0.

Using thus calculated affine parameters (s, t, and θ) the correction section 57 then performs transformation inverse to the affine transformation for correcting (positioning) the position (x′, y′) of the captured image 152 to the position (x, y) of the reference image 151. As a result, as shown in FIG. 4, the captured image 152 is so corrected that the position alignment is derived between the object 161 on the reference image 151 and the object 162 on the captured image 152.

In the image capture section 41, the number of pixels for imaging is larger than the effective number of pixels adopted for the captured image 152. In a real world, actually captured is an image 182 being larger, i.e., having the larger number of pixels, than the captured image 152.

After correcting the image 182 including the captured image 152, the correction section 57 extracts, from the image 182, an image of the range perfectly matching the range of the reference image 151. The extraction result is supplied to the adding image generation section 58 as the corrected captured image 152.

Note here that a determination factor for the size of the image 182, i.e., how much larger than the captured image 152 (in terms of pixel), is a statistic of camera shake when a user holds a camera for imaging.

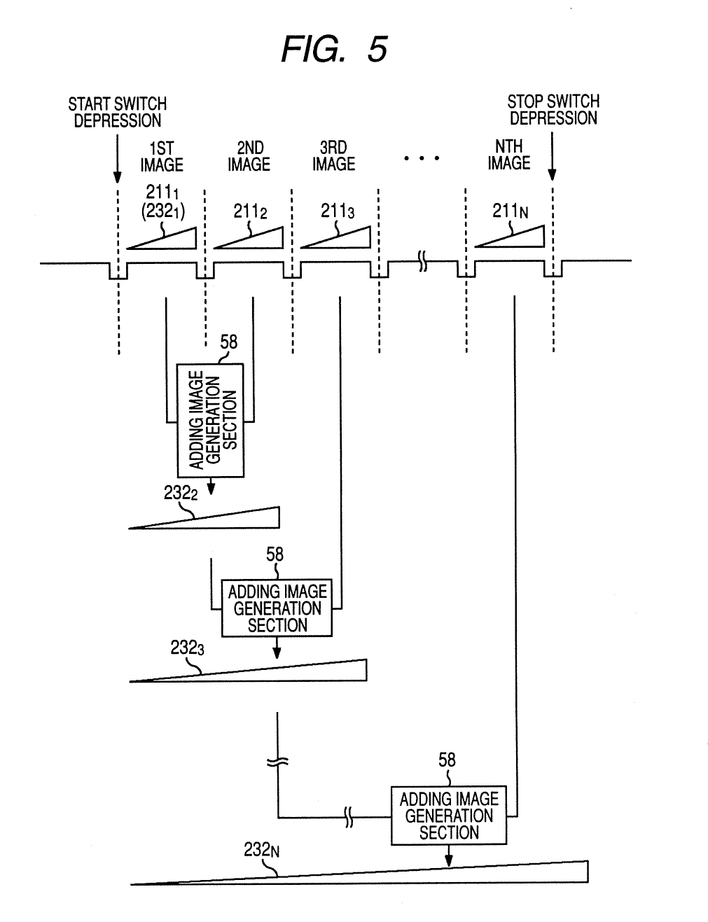

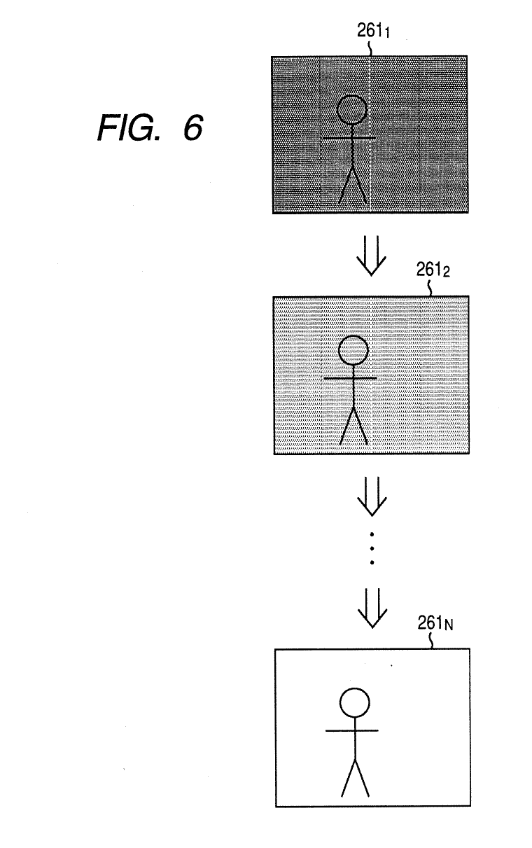

By referring to FIGS. 5 and 6, described next is an adding image to be generated by the adding image generation section 58 of FIG. 1.

FIG. 5 is a diagram showing how a new adding image is generated in the adding image generation section 58.

The upper portion of FIG. 5 represents the exposures 211₁ to 211_{N} of first to N-th images captured with the exposure time not long enough for correct exposure. The left side of FIG. 5 represents the exposures 232₁ to 232_{N} of adding images to be generated by the adding image generation section 58.

The adding image generation section 58 uses, as it is, the first captured image provided by the correction section 57 as an adding image with the exposure 211₁ (232₁).

The adding image generation section 58 adds together the adding image with the exposure 232₁ and the second captured image provided by the correction section 57. The resulting adding image generated thereby is with the exposure 232₃, i.e., exposure being the addition result of the exposures 232₁ and 211₂. The adding image generation section 58 then adds together the adding image with the exposure 232₂ and the third captured image provided by the correction section 57. The resulting adding image generated thereby is with the exposure 232₃. By repeating such a process, the adding image generation section 58 adds together the adding image with the exposure 232ₙ₋₁ and the n-th captured image provided by the correction section 57. The resulting adding image generated there by is with the exposure 232_{N}, i.e., n=2, 3, . . , N−1, and N.

FIG. 6 shows an exemplary display of an adding image on the display section 61 of FIG. 1.

As described in the foregoing, every time a new adding image is generated, the display section 61 responsively displays the new adding image.

As shown in FIG. 6, on the display section 61, the adding image 261₁ with the exposure 232₁ is first displayed, and then the adding image 261₂ with the exposure 232₂ is displayed. As such, every time the adding image generation section 58 generates an adding image 261ₙ, any newly-generated adding image 261ₙ is displayed (n=1, 2, . . . , N−1, and N).

As described above, the adding image 261n is newly generated while the release switch 31 is being depressed. As such, when an adding image 261_{N} with any desired exposure is displayed on the display section 61, a user may stop depressing the release switch 31 so that the adding image 261_{N} with his or her desired exposure is stored (captured) in the storage section 63 or the memory card 65.

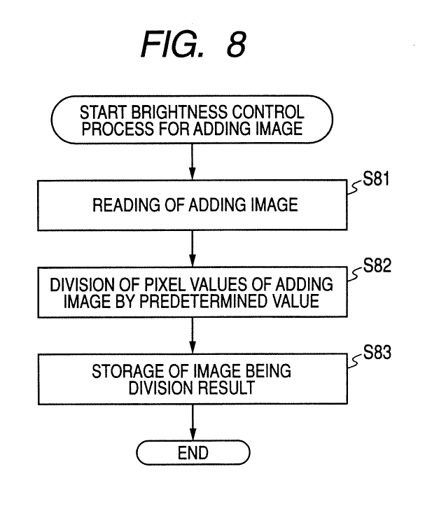

Considered here is a case where the adding image 261_{N} displayed on the display section 61 is found too bright because the user keeps depressing the release switch 31. In this case, the brightness of the adding image 261_{N} can be adjusted by the input/output control section 62 dividing each of the pixel values by a predetermined value in the adding image 261_{N}. This will be described later by referring to the flowchart of FIG. 8.

By referring to the flowchart of FIG. 7, described next is a process in a bulb shooting mode in the digital camera 11 of FIG. 1.

When the user starts depressing the release switch 31, in step S31, the imaging section 41 captures an image of an object with an exposure time not long enough for correct exposure. The resulting captured image is supplied to the SDRAM 54 for storage therein, and the procedure goes to step S32.

In step S32, the motion vector detection section 55 reads, from the SDRAM 54, the captured images derived by the imaging section 41 in the captured order. In step S32, the motion vector detection section 55 determines whether the captured image read from the SDRAM 54 is the first captured image or not. When the motion vector detection section 55 determines that the image is the first captured image, the procedure goes to step S33. In step S33, via the correction section 57 and the adding image generation section 58, the first captured image is supplied to the SDRAM 59 for storage therein as an adding image. The first captured image is also supplied to the SAD table 56 for storage therein as a reference image, and the procedure then goes to step S38.

On the other hand, in step S32, when the motion vector detection section 55 determines that the image is not the first captured image, i.e., the image is the second captured image or thereafter, the procedure goes to step S34. For the second captured image or thereafter read from the SDRAM 54, detected is a motion vector representing the motion of the captured image with respect to the reference image stored in the SAD table 56. The resulting motion vector is provided to the correction section 57 together with the captured image, and the procedure goes to step S35.

In step S35, using the motion vector provided by the motion vector detection section 55 and Equation 1, the correction section 57 calculates the affine parameters (s, t, and θ) by the least squares method, and the procedure goes to step S36. In step S36, using thus calculated affine parameters (s, t, and θ), the correction section 57 corrects the captured image provided by the motion vector detection section 55, and supplies the captured image through with the correction to the adding image generation section 58. The procedure then goes to step S37.

In step S37, the adding image generation section 58 reads an adding image from the SDRAM 59, and adds together the adding image and a pixel value of the corrected captured image provided by the correction section 57. The resulting image is then supplied to the SDRAM 59 as a new adding image, and then is updated and stored. The procedure then goes to step S38.

In step S38, the display control section 60 reads the adding image stored in the SDRAM 59 in step S33 or S37 executed immediately there before. Thus read adding image is then supplied to the display section 61 for display thereon, and the procedure goes to step S39.

In step S39, the adding image generation section 58 determines whether the release switch 31 is kept being depressed. In step S39, when the adding image generation section 58 determines that the release switch 31 is kept being depressed, the procedure returns to step S31, and the process similar to the above is repeated. As such, in step S37, every time the adding image generation section 58 generates a new adding image, the new adding image is accordingly displayed on the display section 61.

On the other hand, in step S39, when the adding image generation section 58 determines that the release switch 31 is not being depressed anymore, i.e., a user who kept depressing the release switch 31 stops depressing the release switch 31 because he or she finds an image (adding image) with any desired exposure by looking at the adding image displayed on the display section 61, the procedure goes to step S40. In step S40, the input/output control section 62 reads, from the SDRAM 59, the adding image, i.e., adding image displayed on the display section 61 when depression of the release switch 31 is stopped. Thus read adding image is supplied to the storage section 63 or the memory card 65 (via the drive 64) for storage therein. The process is then ended.

With such a process in a bulb shooting mode, the imaging section 41 captures an image of an object with an exposure time not long enough for correct exposure. Compared with an image captured with the normal shooting mode, the resulting image is thus freed from blurring.

Moreover, the correction section 57 corrects the position of the image captured by the imaging section 41 to the position of the reference image. As such, any image shake (position displacement) due to camera shake or others during shooting can be corrected.

Every time the adding image generation section 58 generates an adding image, the display section 61 displays thereon the adding image so that a user can check, in real time, the exposure of the adding image. This enables the user to derive an image (adding image) with his or her desired exposure.

Also with such a process in the bulb shooting mode, while the release switch 31 is being depressed, the images captured with the exposure time not long enough for correct exposure are added together. At the time of imaging with low luminance, for example, the user can thus derive the adding image with the better S/N ratio, with the larger dynamic range, and with the higher definition compared with an image captured with the normal shooting mode.

After starting depressing the release switch 31, the user also can derive an image with any desired (preferred) exposure only by stopping depression of the release switch 31 when the display section 61 displays thereon an image with his or her desired exposure.

Considered here is a case with the process in the bulb shooting mode of FIG. 7 where an image (adding image) is derived with exposure exceeding user's desired exposure because the user kept depressing the release switch 31 due to his or her carelessness, for example. If this is the case, in the digital camera 11, the exposure of the image is substantially lowered by a process execution so that the image brightness can be favorably controlled.

By referring to the flowchart of FIG. 8, described next is a brightness control process by lowering the exposure of an adding image.

Assumed here is a case where a user operates the operation section 21 in such a manner that an adding image stored in the storage section 63 or the memory card 65 is displayed on the display section 61. In this case, in step S81, the input/output control section 62 reads the adding image stored in the storage section 63 or the memory card 65, and supplies the adding image to the SDRAM 59 for storage therein. In step S81, when the adding image is stored in the SDRAM 59, the display control section 60 reads the adding image from the SDRAM 59, and makes the display section 61 display thereon the adding image. The procedure then goes to step S82.

In step S82, when the user operates the operation section 21 in such a manner that the brightness control is exercised over the adding image displayed on the display section 61, the input/output control section 62 reads the adding image from the SDRAM 59, and divides each of the pixel values of the adding image by a predetermined value in accordance with the user's operation. The image being the division result (herein after, referred to as divided image) is supplied to the SDRAM 59 for storage therein. In step S82, the display control section 60 reads the divided image from the SDRAM 59 for display on the display section 61.

The procedure then goes from step S82 to S83. In step S83, after checking the divided image displayed on the display section 61, when the user operates the operation section 21 so as to confirm the divided image displayed on the display section 61, the input/output control section 62 reads the divided image from the SDRAM 59 for supply to the storage section 63 or the memory card 65. The divided image is then updated over the original addition image, and then stored. This is the end of the process.

In step S82, the display control section 60 makes the display section 61 display thereon the divided image read from the SDRAM 59. This enables the user to check the divided image for its exposure. As such, the process of step S82 can be repeated until the user derives his or her desired divided image.

Note here that, in step S83, the divided image is updated over the original addition image, and then is stored. This is surely not restrictive, and the divided image may be stored separately from the original adding image.

The series of processes to be executed by the above-described components, i.e., the motion vector detection section 55, the correction section 57, the adding image generation section 58, the display control section 60, and the input/output control section 62, maybe executed by any specific hardware or software. When such series of processes is to be executed by software, a program configuring the software is installed from a program storage medium to a so-called built-in computer, a general-purpose personal computer capable of various functions with various types of programs installed therein, or others.

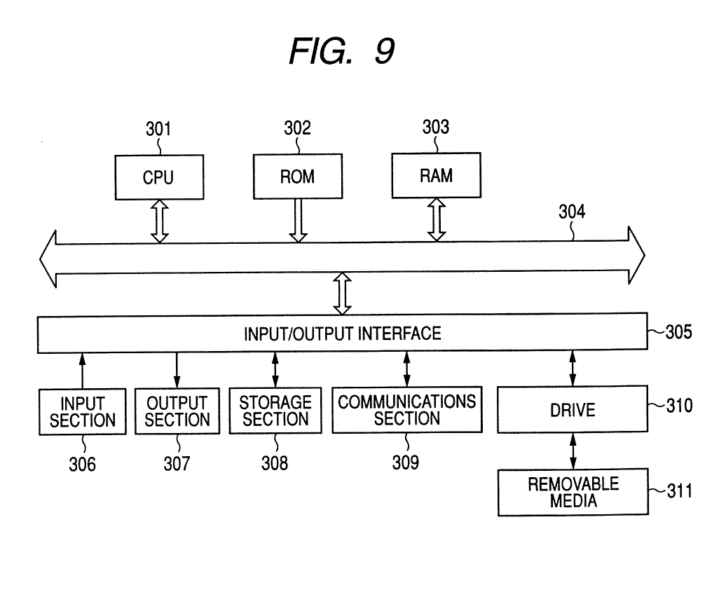

FIG. 9 is a block diagram showing an exemplary configuration of a computer executing the above-described series of processes by a program.

A CPU (central Processing Unit) 301 goes through various types of processes by following a program stored in a ROM (Read Only Memory) 302 or a storage section 308. A RAM (Random Access Memory) 303 stores therein programs and data for execution by the CPU 301 as appropriate. These components, i.e., the CPU 301, the ROM 302, and the RAM 303, are connected together over a bus 304.

The CPU 301 is connected with an input/output interface 305 via the bus 304. The input/output interface 305 is connected with an input section 306 and an output section 307. The input section 306 is configured to include a keyboard, a mouse, a microphone, and others, and the output section 307 is configured to include a display, a speaker, and others. The CPU 301 executes various types of processes in response to a command coming from the input section 306. The CPU 301 then outputs the process results to the output section 307.

A storage section 308 connected to the input/output interface 305 is exemplified by a hard disk, and stores therein programs to be executed by the CPU 301 and various types of data. A communications section 309 establishes a communications link with any external device over a network such as the Internet and local area network.

Alternatively, program acquisition may be performed over the communications section 309, and thus acquired programs may be stored in the storage section 308.

A drive 310 connected to the input/output interface 305 drives a removable medium 311 when it is attached, and acquires programs, data, and others recorded thereon. The removable medium 311 is exemplified by a magnetic disk, an optical disk, a magneto-optical disk, or a semiconductor memory. Thus acquired programs and data are transferred to the storage section 308 if required, and then stored.

A program storage medium is installed in a computer for use to store a program to be ready for execution by the computer. As shown in FIG. 9, such a program storage medium is configured by the removable medium 311, the ROM 302, a hard disk configuring the storage section 308, or others. The removable medium 311 is a package medium including a magnetic disk (including flexible disk), an optical disk (including CD-ROM (Compact Disc-Read Only Memory, DVD (Digital Versatile Disc)), a magneto-optical disk (including MD (Mini-Disc)), a semiconductor memory, or others. The ROM 302 stores therein a program(s) temporarily or permanently. The program storage to such a program storage medium is made, as appropriate, via the communications section 309 such as router or modem by utilizing a communications medium via a cable or by radio such as local area network, the Internet, and digital satellite broadcasting.

In this specification, the step description for a program stored in a program storage medium includes not only time-series processes to be executed in the described order but also processes to be executed not necessarily in a time series manner but in a parallel manner or separately.

In such a process in a bulb shooting mode, the motion vector detection section 55 of FIG. 1 is described above as detecting a motion vector by block matching. The motion vector is not necessarily detected as such, and may be detected by a gradient method, for example.

Alternatively, the motion vector detection section 55 of FIG. 1 may detect a motion vector using a reference image scaled down by any appropriates calling ratio, and captured images (second captured image and thereafter).

The correction section 57 of FIG. 1 is described as being in charge of correction for position alignment of an object by the affine transformation. Alternatively, by using a sensor such as angular velocity sensor or acceleration sensor in the digital camera 11, any image shake is detected, and any optical correction may be performed.

The display control section 60 is described as, every time the adding image generation section 58 generates a new adding image for supply to and storage in the SDRAM 59, reading the adding image from the SDRAM 59 for display on the display section 61. Alternatively, the adding image to be generated by the adding image generation section 58 may be displayed for every m (<N) pieces. With this being the case, every time the adding image generation section 58 generates a new adding image, the display control section 60 can reduce the process load for display of the adding image compared with the case of making the display section 61 display thereon the adding image.

It should be understood by those skilled in the art that various modifications, combinations, sub-combinations and alterations may occur depending on design requirement sand other factors insofar as they are within the scope of the appended claims or the equivalents thereof.

What is claimed is:

1. An imaging apparatus for capturing an image, comprising:
imaging means for capturing an image by subjecting an incoming light to photoelectric conversion;
operation means for being operated by a user;
adding image generation means for adding, while the operation means is being operated, an image captured by the imaging means with an exposure time not long enough for correct exposure, and generating an adding image; and
recording control means for recording the adding image to a recording medium when the operation means is stopped for operation.

2. The imaging apparatus according to claim 1, further comprising:
display means for displaying an image; and
display control means for making, every time the adding image being a new addition result with the image captured by the imaging means is generated, the display means display the adding image being the new addition result.

3. The imaging apparatus according to claim 1, further comprising
division means for dividing a pixel value of the adding image by a predetermined value.

4. The imaging apparatus according to claim 1, further comprising
correction means for correcting, while the operation means is being operated, the image plurally captured by the imaging means to deriver positional alignment of an object therein, wherein
the adding image generation means adds the image through with the correction by the correction means.

5. An imaging method for use with an imaging apparatus equipped with imaging means for capturing an image by subjecting an incoming light to photoelectric conversion, the method comprising the steps of:
generating, while operation means for being operated by a user is being operated, an adding image by adding an image captured by the imaging means with an exposure time not long enough for correct exposure; and
recording the adding image to a recording medium when the operation means is stopped for operation.

6. A program for use with a computer to execute an imaging process of an imaging apparatus equipped with imaging means for capturing an image by subjecting an incoming light to photoelectric conversion, the program comprising the steps of:
generating, while operation means for being operated by a user is being operated, an adding image by adding an image captured by the imaging means with an exposure time not long enough for correct exposure; and
recording the adding image to a recording medium when the operation means is stopped for operation.

7. An imaging apparatus for capturing an image, comprising:
imaging means for capturing an image by subjecting an incoming light to photoelectric conversion;
adding image generation means for adding an image captured by the imaging means with an exposure time not long enough for correct exposure, and generating an adding image;
display means for displaying an image;
and
display control means for making, every time the adding image being a new addition result with the image captured by the imaging means is generated, the display means display the adding image being the new addition result.

8. The imaging apparatus according to claim 7, further comprising
recording control means for recording the adding image to a recording medium.

9. The imaging apparatus according to claim 7, further comprising
division means for dividing a pixel value of the adding image by a predetermined value.

10. The imaging apparatus according to claim 7, further comprising
correction means for correcting the image plurally captured by the imaging means to derive positional alignment of an object therein, wherein
the adding image generation means adds the image through with the correction by the correction means.

11. An imaging method for use with an imaging apparatus equipped with imaging means for capturing an image by subjecting an incoming light to photoelectric conversion, the method comprising the steps of:
generating an adding image by adding an image captured by the imaging means with an exposure time not long enough for correct exposure; and
making, every time the adding image being a new addition result with the image captured by the imaging means is generated, display means display the adding image being the new addition result.

12. A program for use with a computer to execute an imaging process of an imaging apparatus equipped with imaging means for capturing an image by subjecting an incoming light to photoelectric conversion, the program comprising the steps of:
generating an adding image by adding an image captured by the imaging means with an exposure time not long enough for correct exposure; and
making, every time the adding image being a new addition result with the image captured by the imaging means is generated, display means display the adding image being the new addition result.

13. An imaging apparatus for capturing an image, comprising:
an imaging section capturing an image by subjecting an incoming light to photoelectric conversion;
an operation section being operated by a user;
an adding image generation section adding, while the operation means is being operated, an image captured by the imaging means with an exposure time not long enough for correct exposure, and generating an adding image; and
a recording control section recording the adding image to a recording medium when the operation means is stopped for operation.

14. An imaging apparatus for capturing an image, comprising:
an imaging section capturing an image by subjecting an incoming light to photoelectric conversion;
an adding image generation section adding an image captured by the imaging means with an exposure time not long enough for correct exposure, and generating an adding image;
a display section displaying an image;
and
a display control section making, every time the adding image being a new addition result with the image captured by the imaging means is generated, the display means display the adding image being the new addition result.
